(19) United States
(12) Patent Application Publication
(10) Pub. No.: US 2008/0016862 A1
(43) Pub. Date: Jan. 24, 2008

(54) Hydraulic Switching Arrangement, Particularly for the Drive of Concrete Spreader Masts

(75) Inventors: Paul Von Baumen, Sindelfingen (DE); Hartmut Benckert, Filderstadt (DE); Werner Munzenmaier, Nurtingen (DE)

Correspondence Address: WILLIAM COLLARD;COLLARD & ROE, P.C., 1077 NORTHERN BOULEVARD, ROSLYN, NY, 11576, US

(73) Assignee: PUTZMEISTER AKTIENGESELLSCHAFT, Aichtal (DE)

(21) Appl. No.: 11/664,628

(22) PCT Filed: May 26, 2006
(86) PCT No.: PCT/EP06/05043

§ 371 Date: Apr. 4, 2007

(30) Foreign Application Priority Data
Jul. 28, 2005 (DE) 10 2005 035 981.7

(51) Int. Cl. F15B 11/00

(52) U.S. Cl. 60/464

(57) ABSTRACT

The invention relates to a hydraulic circuit arrangement, in particular for the drive of concrete distributor masts. The circuit arrangement comprises at least one hydraulic load (34, 35, . . . ), the latter being connected at the inlet side by means of a feed line (64) to the pressure outlet of a hydraulic positive displacement pump (60), and comprises at least one proportional valve (56) which is arranged in the feed line (64), is assigned one of the loads and, in its rest position, blocks the feed line (64), and in an operating position, forms a throttle aperture (57) with a variable opening cross section. Also provided in the feed line (64) is a reversing group (82), which in the standby state is connected to the tank (62) and in the operating position is connected to the at least one load (34, 35, . . . ). The positive displacement pump (60) has an adjusting element (58) which is controlled by means of a feed flow regulator (70) which is arranged in the pump branch (111) and comprises a directional control valve (71), one pilot control inlet of which is pressurized with the pressure (p) prevailing at the outlet of the positive displacement pump (60) and the opposite pilot control inlet of which is spring-loaded with a defined preload force and is additionally pressurized with the load pressure (pLS) prevailing downstream of the throttle aperture (57). In order to ensure reliable operation even in the start-up phase, according to the invention, a control group (107) which reacts to the load pressure (pLS) is provided with a switching valve (100) which, below a predefined minimum valve of the load pressure (pLS), places the adjusting element (58) of the positive displacement pump (60) into its position for maximum feed flow.

The invention relates to a hydraulic switching arrangement, particularly for the drive of concrete spreader masts, having at least one hydraulic consumer connected on the input side with the pressure output of a hydraulic adjustment pump, by way of a feed line; having at least one proportional valve assigned to one of the consumers, in each instance, disposed in the feed line, which valve blocks the feed line in its rest position and forms a throttle plate having a variable opening cross-section in its operating position; having a rerouting group disposed in the feed line, connected with a tank in the rest state, and with the at least one consumer in the operating position; having an adjustment organ disposed in the adjustment pump, which is controlled by way of a transport flow regulator disposed in a pump branch, whereby the transport flow regulator comprises a directional control valve, the one pilot-control input of which has the pump pressure prevailing at the pressure output of the adjustment pump applied to it, and whose opposite pilot-control input is spring-loaded with a defined bias, and additionally has the load pressure prevailing behind the throttle plate applied to it.

Possible consumers are, for example, the hydro-cylinders that are used for moving the mast arms of a concrete spreader mast configured as a bending mast (DE-10107107 A1). The switching arrangement according to the invention contains a load-pressure-guided transport flow regulator (load-sensing regulator) that coordinates the displacement volume of the adjustment pump with the transport amount required by the consumer. In this connection, the transport flow of the adjustment pump depends on the position of the throttle plate in the proportional valve disposed between the adjustment pump and the consumer. For this purpose, the directional control valve in the transport flow regulator compares the pressure in front of the throttle plate and behind the throttle plate, and holds the difference pressure that occurs there, and therefore the volume flow, constant. If the difference pressure increases, the adjustment organ of the adjustment pump is set back; if the difference pressure drops, the adjustment organ is shut off until the equilibrium in the directional control valve has been restored. Setting of the difference pressure takes place by way of the defined bias force on the spring side of the directional control valve. In the case of concrete pumps, the setting range usually lies between 14 and 25 bar; for practical purposes, 18 bar. In stand-by operation, in which the proportional valve is blocked, the hydraulic oil is transported to the tank, by way of a cooler, at maximal transport flow, in circulation, by way of the adjustment pump, and thereby used for system cooling. In this connection, it is felt to be disadvantageous that in stand-by operation, there is a relatively high demand for energy in order to transport the hydraulic oil, and therefore high fuel consumption occurs. Furthermore, it has been shown that during the start-up process, with a load-pressure-guided transport flow regulator, malfunctions can occur, which lead to an undesirable pressure collapse and an oil deficiency resulting from it. This error is due to the fact that at the beginning, only the pump pressure is acting on the transport flow valve, at first, without a load-sensing signal being present on the spring side. This means that if the pressure difference set by way of the spring is exceeded, the adjustment organ of the adjustment pump is displaced in the closing direction some of the time, by way of the directional control valve of the transport flow regulator, and thereby causes an oil deficiency.

Proceeding from this, the invention is based on the task of improving the hydraulic switching arrangement of the type indicated initially in such a manner that pump operation in the start-up phase and/or in stand-by operation is optimized.

To accomplish this task, the combination of characteristics indicated in claims 1, 16, or 17 is proposed. Advantageous embodiments and further developments of the invention are evident from the dependent claims.

A first solution variant of the invention provides that a control group responding to the load pressure is provided, which group switches through the directional control valve from the spring side below a pre-determined minimum value of the load pressure, and thereby brings the pilot-control organ of the adjustment pump into its position for maximal transport flow. The control group according to the invention therefore ensures that the adjustment pump is operated at maximal transport flow during the entire start-up process, without taking the load pressure that builds up with a time delay into consideration, so that no pressure collapse and therefore also no oil deficiency occurs. It is practical that for this purpose, the control group has a control valve biased against the pressure of a spring, under the effect of the load pressure, which valve switches through the pump pressure on the spring side of the directional control valve in the transport flow regulator when the load pressure goes below a minimum value.

A purely hydraulic embodiment variant provides, in this connection, that the control valve has the load pressure directly applied to it at its pilot-control input that lies opposite the spring, while the spring pressure set by way of the spring corresponds to the pre-determined minimum value of the load pressure. A typical minimum value for the load pressure lies at 80 to 150 bar, preferably at about 100 bar.

According to an electro-hydraulic embodiment variant, a pressure switch or pressure detector that responds to the minimum value of the load pressure, to which the load pressure is applied, is provided, while the pilot-control input of the directional control valve that lies opposite the spring is disposed in the circuit of the pressure switch or the pressure detector and can be electrically and/or magnetically activated by this circuit. In this case, the switching process is triggered by way of the pressure switch or the pressure detector, so that the spring functions as a re-set spring in the directional control valve, which spring can be designed to be relatively weak.

Another preferred embodiment of the invention provides that the control group is connected with the input of a change-over valve, by way of an output-side throttle, the second input of which valve has the load pressure applied to it, and the output of which valve is connected with the spring side of the directional control valve of the transport flow regulator. In this case, a pressure-limiting valve connected with the tank, disposed on the output side, can be connected with the control group. Furthermore, another pressure-limiting valve connected with the tank, which limits the maximal operating pressure, is connected with the feed line.

It is practical if a pressure regulator disposed behind the transport flow regulator is disposed in the pump branch, in addition to the transport flow regulator, to control the adjustment organ of the adjustment pump.

A preferred embodiment of the invention provides that the adjustment organ of the adjustment pump is coupled with at least one lifting cylinder activated by the transport flow regulator and/or the pressure regulator, whereby at least one of the lifting cylinders is spring-loaded, preferably in the opening direction of the adjustment organ.

In the case of a bending mast for concrete pumps, several drive units assigned to the bending axes, in the form of hydro-cylinders, must be switched through by way of the switching arrangement. Accordingly, several consumers are provided there, to which a proportional valve is assigned, in each instance. Since only the highest load pressure must be selected for the load-pressure-guided transport flow regulation, in each instance, it is practical, in this case, that the load branches of the individual consumers are connected with the control group and the directional control valve by way of a change-over valve that allows the highest load pressure signal to come through.

Another advantageous or alternative embodiment variant of the invention provides that the rerouting group has a rerouting valve that is optionally connected with the consumer or the tank, from the feed line, that a throttle is disposed in the line leading to the tank, that the rerouting group has an input module with a spring-supported shut-off valve, which is connected with the feed line on the input side and with the tank on the output side, and is pilot-controlled on its spring side, by way of the output of the throttle, and has the pump pressure applied to it on the pilot-control side that lies opposite the spring. In order to guarantee optimal stand-by operation, it is proposed, in this connection, either
that the hydraulic pressure resulting from the spring force of the adjustable spring of the input module is equal to or greater than the hydraulic pressure resulting from the spring force of the setting spring of the transport flow regulator, so that the adjustment organ of the adjustment pump assumes its smallest opening position or its closed position, respectively, in the rest state of the rerouting group, or
that the hydraulic pressure resulting from the spring force of the adjustable spring of the input module is less than the hydraulic pressure resulting from the spring force of the setting spring of the transport flow regulator, and in this connection is dimensioned in such a manner that the adjustment organ of the adjustment pump assumes a pre-determined intermediate position between its smallest possible and largest possible open position in the rest position of the rerouting group.

In this connection, the spring pressure, in each instance, can be set to a pre-determined value in order to adjust the spring force, by way of a setting organ.

In the former case, the transport flow is set to zero or to a minimal value in stand-by operation, by way of the selection of a sufficiently great spring force at the input module, while in the latter case, an intermediate value can be set for the transport flow. In this way, not only the energy requirement and therefore the fuel consumption, but also the noise development can be reduced in stand-by operation.

In the following, the invention will be explained in greater detail using exemplary embodiments shown schematically in the drawing. This shows:

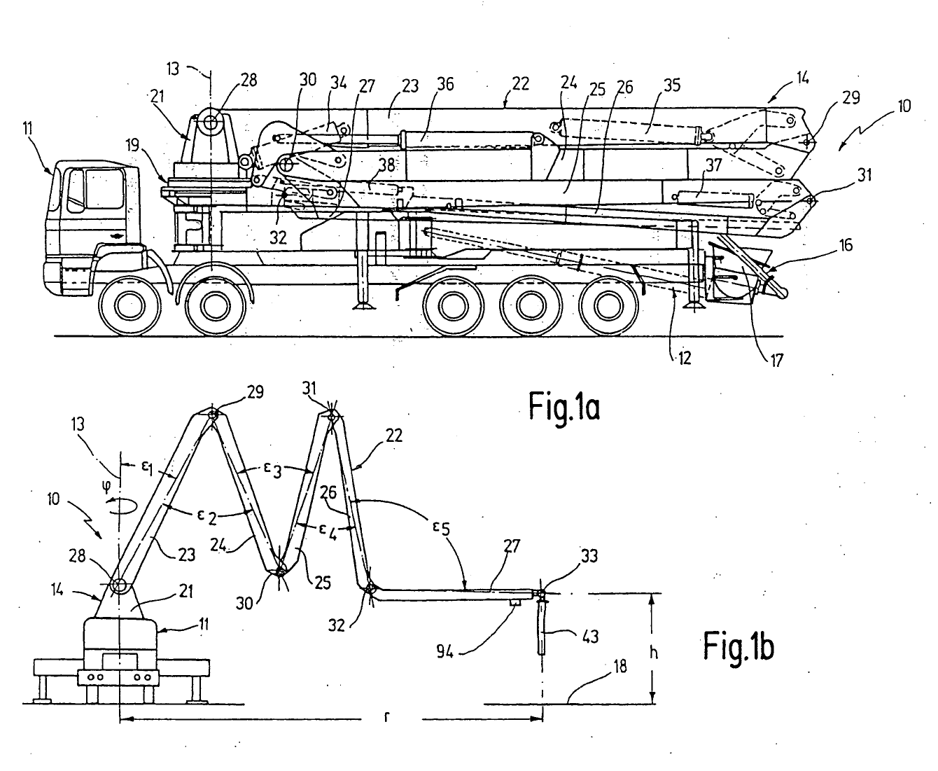

FIG. 1a and b a side view of a vehicle-mounted concrete pump with collapsed bending mast, and, in a simplified representation, with bending mast in the working position;

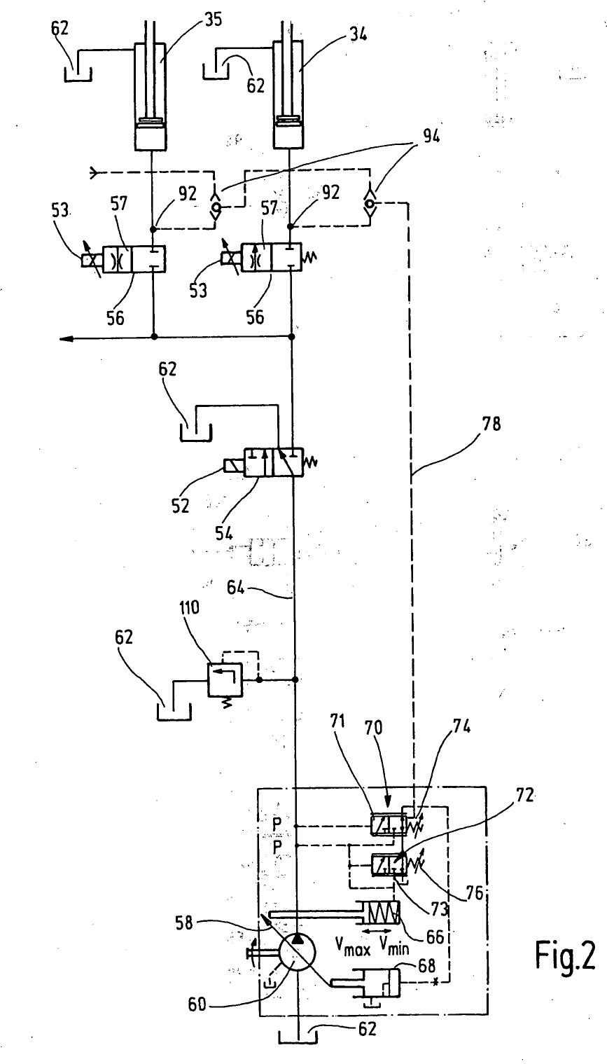

FIG. 2 a hydraulic switching arrangement for controlling hydraulic consumers according to the previously known state of the art;

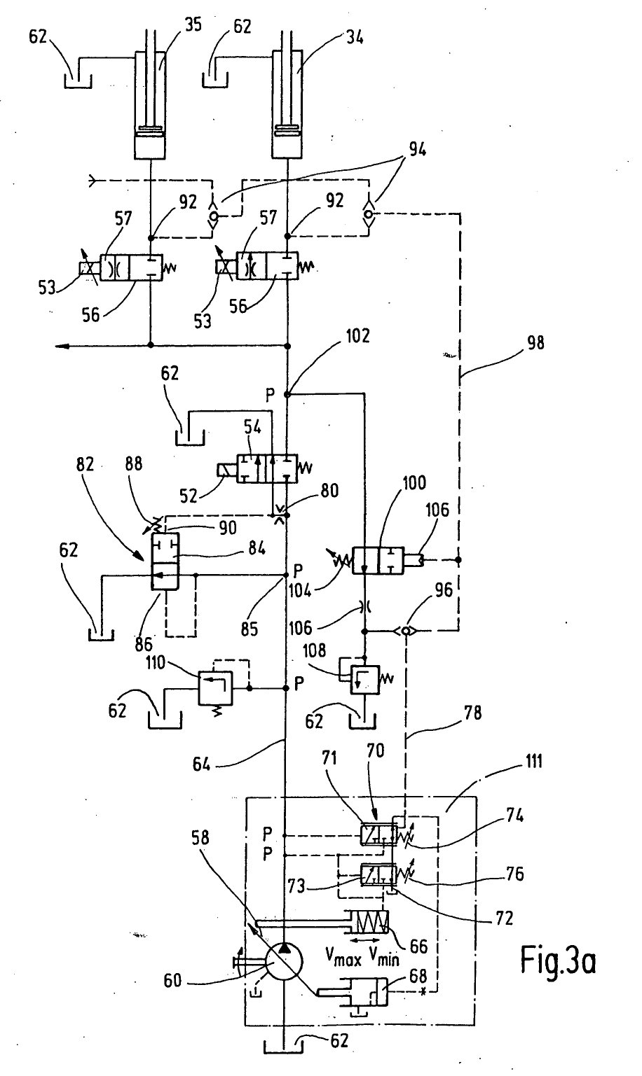

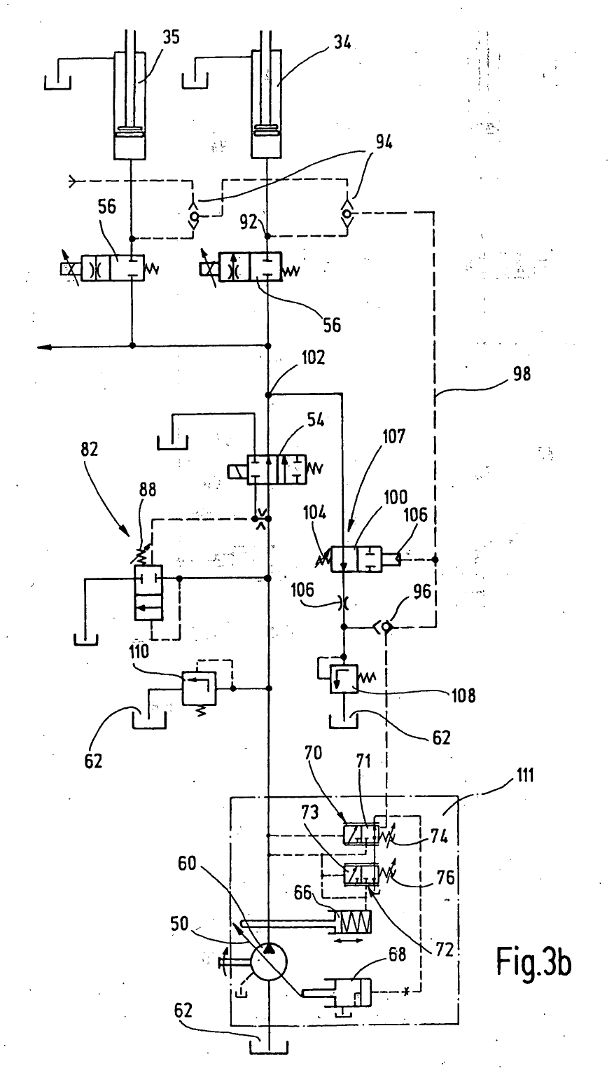

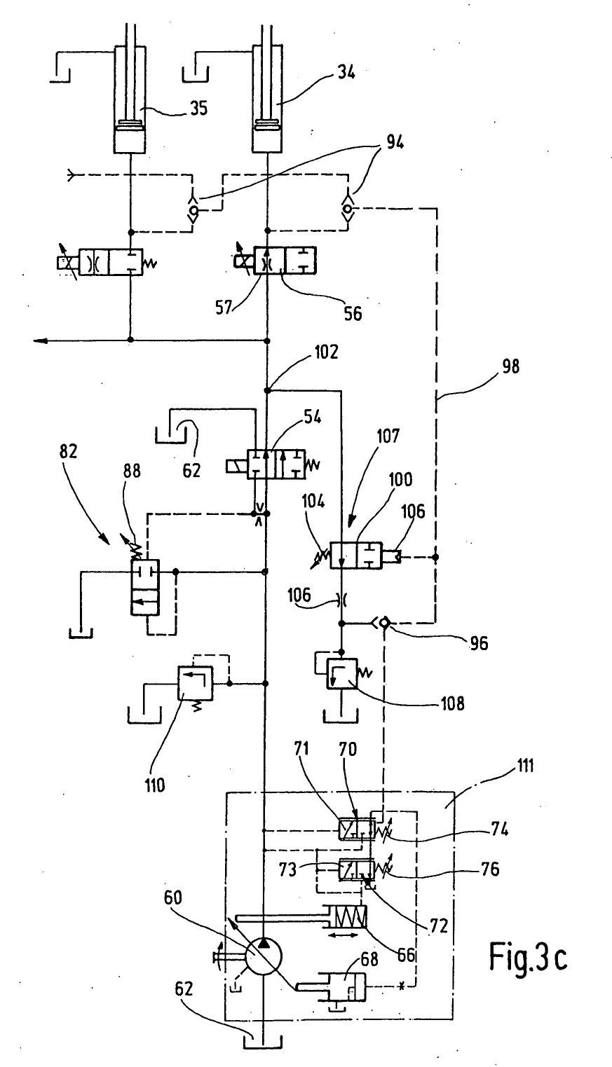

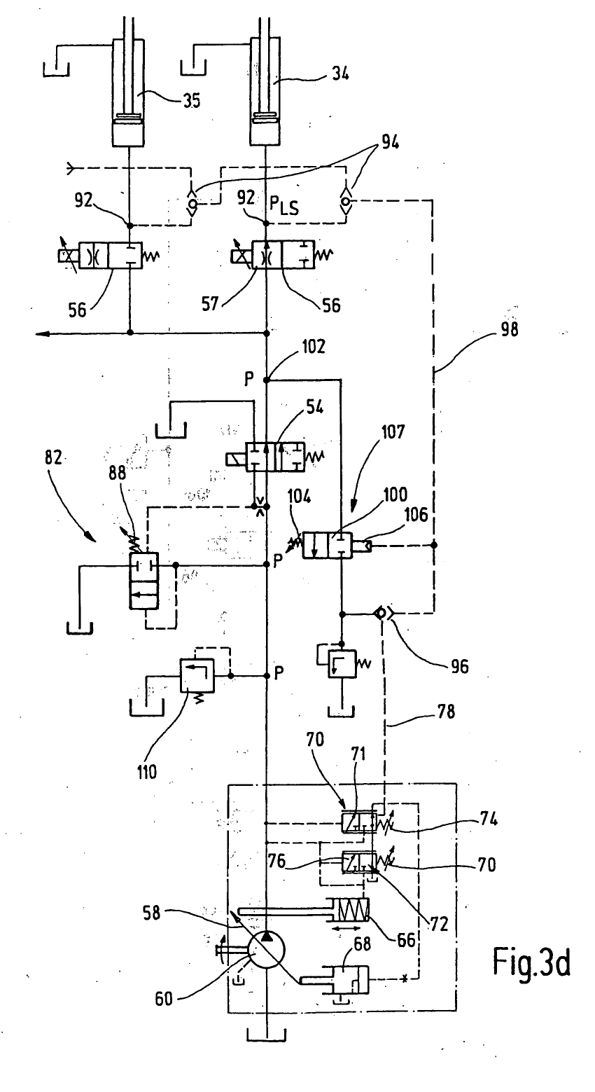

FIG. 3a to d a hydraulic switching arrangement for control, with a hydraulically activated control group according to the invention; and

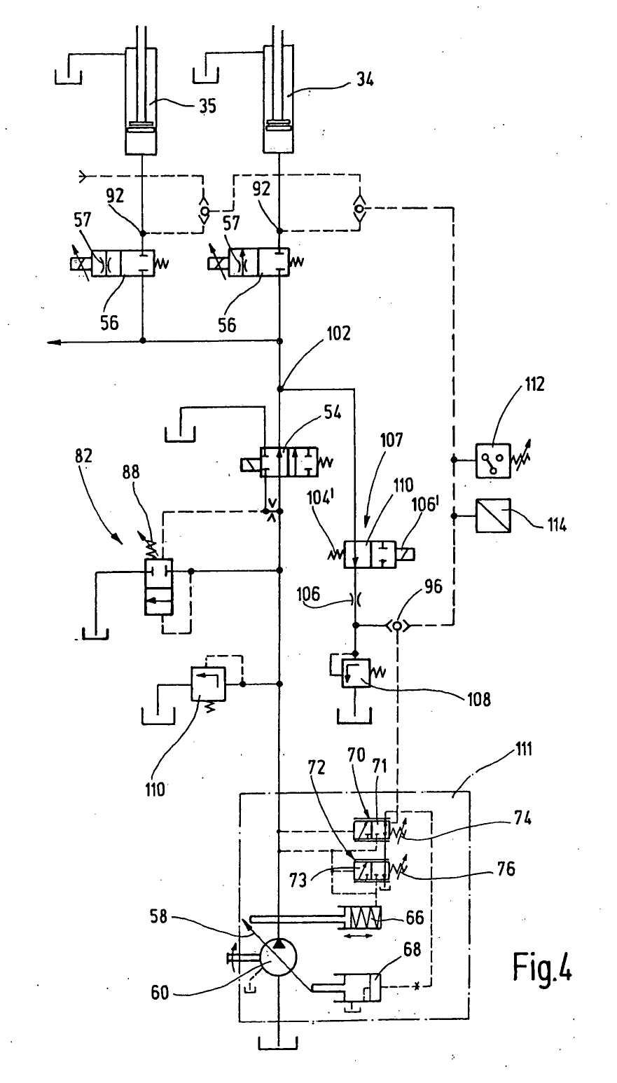

FIG. 4 a switching arrangement according to FIG. 3a to d, with an electrically activated control group according to the invention.

The hydraulic switching arrangements shown in FIG. 2 to 4 can be used, for example, to control the drive units of the spreader mast 14 of a vehicle-mounted concrete pump, configured as hydro-cylinders 34 to 38.

FIG. 1a and b show, as an illustration and as an example, a vehicle-mounted concrete pump 10 that comprises a transport vehicle 11, a thick-matter pump 12 configured as a two-cylinder piston pump, for example, as well as a concrete spreader mast 14 that can be rotated about an upright axle 13 fixed to the vehicle, as a support for a concrete transport line 16. Liquid concrete, which is continuously introduced into an application container 17 during concrete placement is transported, to a concrete placement location 18 disposed at a distance from the location of the vehicle 11, by way of the concrete transport line 16.

The spreader mast 14 consists of a mast base 21 that can be rotated about the upright axle 13 by the angle φ by means of a hydraulic rotary drive 19, and a bending mast 22 that can pivot on the base, which is continuously adjustable to variable reach r and height difference h between the vehicle 11 and the concrete placement location 18. In the exemplary embodiment shown, the bending mast 22 consists of five mast arms 23 to 27 connected with one another in articulated manner, which can pivot about axles 28 to 32 that run parallel to one another and at a right angle to the upright axle 13 of the mast base 21. The bending angles ε1 to ε5 (FIG. 1b) of the bending joints formed by the bending axles 28 to 32, and their arrangement relative to one another, are coordinated with one another in such a manner that the spreader mast 14 can be laid down onto the vehicle 11 in the transport configuration shown in FIG. 1a, corresponding to multiple folding. By means of activation of the hydraulic consumers 34 to 38 formed as hydro-cylinders 34 to 38, which are individually assigned to the bending axles 28 to 32, the bending mast 22 can be unfolded at different distances r and/or height differences h between the concrete placement location 18 and the vehicle location (FIG. 1b). During the movement, the mast tip 33 with the end hose 43 is guided over the region 18 in which the concrete is to be placed.

Control of the consumers 34 to 38 takes place by way of a remote control organ that is not shown, configured as a control lever, which can be adjusted into three main positions, with the issuance of control signals. The control signals are transmitted to a radio receiver mounted in the vehicle, by way of a radio route. The radio receiver is connected to a micro-controller, not shown, by means of which the received control signals are interpreted and converted into activation signals for the pilot-control inputs 52, 53 of the rerouting and proportional valves 54, 56 disposed in the switching arrangement. Activation of the consumers 34 to 40 takes place by way of the rerouting valve 54 and the proportional valves 56. The consumers 34, 35, . . . are shown as single-action hydro-cylinders in FIG. 2 to 4, for the sake of simplicity. In practice, dual-action hydro-cylinders are used for activating the mast arms 23 to 27 of the bending mast 22.

The switching arrangements shown in FIG. 2 to 4 furthermore comprise a motor-operated, adjustable hydraulic adjustment pump 60 that is adjustable by way of an adjustment organ 58 that can pivot, which pump transports hydraulic oil from a tank 62 into a feed line 64. The adjustment organ 58 is continuously adjustable between two end positions, which correspond to a minimal and a maximal transport flow \dot{v}ₘᵢₙ and \dot{v}ₘₐₓ [please see original and fix symbols as needed], by way of two setting cylinders 66, 68, one of which is spring-supported. Control of the setting cylinders 66, 68 takes place by way of a transport flow regulator 70 and a pressure regulator 72, which is switched in parallel with the former, which are configured as spring-centered 2/2-way valves 71, 73, in each instance. The directional control valves 71, 73 have the pressure p at the pressure output of the adjustment pump 60 applied to them at their one pilot-control side, and pilot-controlled by way of a setting spring 74, 76, in each instance, on the opposite pilot-control side. The setting spring 74 of the transport flow regulator 70 is set to 18 bar, for example, while the pressure spring 76 of the pressure regulator is set to 350 bar, for example. Furthermore, a pilot-control line 78 is connected on the spring side of the transport flow regulator 70, to which the highest load pressure p_{LS} is applied at the inputs of the consumers 34, 35, . . . , by way of the pick-up 92. In the operating state, one thereby obtains a load-pressure-guided transport flow regulator (load-sensing regulator) that coordinates the displacement volume of the adjustment pump 60 to the amount required by the consumers 34, 35, . . . . The function of the load-sensing regulator will be described in greater detail below, in the course of the description of the operating state, in connection with FIG. 2 and 3d.

In the feed line 64, there is furthermore the rerouting valve 54 already mentioned above, configured as an optional operating mode valve, which blocks the feed line 64 to the consumers 34, 35, . . . in the stand-by state, and connects it with the tank 62, and switches it through to the consumers 34, 35, . . . in the operating state.

Each consumer 34, 35, . . . has a proportional valve 56 connected to the feed line 64 in a parallel circuit assigned to it, which, just like the rerouting valve 54, can be controlled by way of the remote control device, at its electromagnetic input 52, 53.

The pick-ups 92 for the load pressure signals are situated on the consumer side of the proportional valves 56, in each instance. The change-over valve chain 94 ensures that only the highest load pressure signal p_{LS} is passed through to the pilot-control line 78.

The switching arrangement according to the previously known state of the art, shown in FIG. 2, is designed in such a manner that the transport flow regulator 70 always works with load pressure guidance. However, it has been shown that this mode of operation only functions satisfactorily in stationary operation.

In stand-by operation, the adjustment pump 60 is always set to maximal transport flow, by way of the transport flow regulator 70, if there is no load pressure p_{LS} and an essentially pressureless state in the feed line 64. The hydraulic oil, which is guided to the tank 62 by way of the rerouting valve 54, is used for system cooling in this case. Nevertheless, it is felt to be disadvantageous that the adjustment pump 60 is subject to a power requirement, which is not insignificant, in stand-by operation, for circulating the hydraulic oil; this requires a correspondingly great need for fuel.

Furthermore, during the start-up process, when the rerouting valve 54, at first, and then the one proportional valve 56 or another, with a certain time delay, are switched through in the direction of the consumers 34, 35, . . . , a stationary load pressure p_{LS} will only build up at the pick-up points 92 after a certain period of time. This means that during the start-up phase, at first the volume flow of the adjustment pump 60 is controlled back from the initial maximal throughput by way of the transport flow regulator 70, so that a volume flow and pressure collapse will occur in the feed line 64, some of the time. Only once the load pressure p_{LS} at the pick-up points 92 is sufficiently high will a volume flow guided by the load pressure occur. The consequence of this is that the consumers 34, 35, . . . respond to the setting signals with a delay during the start-up phase.

These disadvantages are avoided with the switching arrangements shown in FIGS. 3a to d and 4.

For optimization of start-up operation, the pilot-control line 78 that leads to the transport flow regulator 70 is guided by way of a change-over valve 96, to which the currently highest load pressure p_{LS} is applied on the one side, by way of the load pressure pick-ups 92 and the change-over valve chain 94, and which is connected with a pressure pick-up 102 in the feed line on the other side, by way of a switching valve 100. The switching valve 100 has a setting pressure of 100 bar, for example, applied to it on the one side, by way of a biased spring 104, which pressure is compared with the current load pressure p_{LS} by way of the pilot-control input 106. As long as the load pressure p_{LS} lies below the bias of the setting spring 104, the pressure p in the feed line 64 is switched through to the change-over valve 96, by way of the switching valve 100, and thereby to the pilot-control input of the transport flow regulator 70, by way of the line 78, so that the adjustment pump 60 is held in its maximal transport flow position, by way of the adjustment organ 58, with the additional effect of the setting spring 74. However, this is only the case if, at the same time, the rerouting valve 54 stands in its operating position, switching the feed line 64 through, and is not in the stand-by state.

The rerouting valve 54 interacts with an input module 82, in the case of the exemplary embodiments shown in FIGS. 3 and 4, by way of a throttle 80, forming a rerouting group 82. The input module contains a switching valve 84 that switches through between feed line 64 and tank 62, particularly in the stand-by state, and is otherwise blocked. The switching valve 84 has a control input 86 to which the pressure p in the feed line 64 is applied, by way of the pick-up 85, as well as an opposite pilot-control side 90 connected with the output of the throttle 80, to which a spring 88 is applied.

With the proviso that the spring force of the spring 88 is selected to be sufficiently high, the switching valve 84 ensures, in stand-by operation, when the valves 54 and 56 are blocked, that the adjustment organ 58 of the adjustment pump 60 is pivoted back into a position with minimal transport flow \dot{v}ₘᵢₙ. This is the case if the pressure built up by way of the spring 88 is greater than the pressure set by way of the setting spring 74 of the transport flow regulator 70. By means of reducing the bias of the spring 88, any desired intermediate positions of the transport flow can also be set at the adjustment pump 60 in the stand-by position. With these measures, the fuel consumption of the drive motor of the adjustment pump 60 can be reduced in stand-by operation.

In the start-up phase, in which first the rerouting valve 54 and subsequently at least one of the proportional valves 56 are switched through, one after the other, in terms of time, the switching valve 100 ensures rapid pressure build-up at the selected consumers 34, 35, . . . . FIG. 3b shows the switching position at which the rerouting valve 54 switches through, but no proportional valve 56 is turned on yet. Here, the operating pressure p builds up very rapidly behind the rerouting valve 54, which pressure is switched through to an input of the change-over valve 96 by way of the pressure pick-up 102 and the switching valve 100, by way of the throttle 106. Since no load pressure p_{LS} is present yet on the other side of the change-over valve 96, the current pump pressure p is switched through to the transport flow regulator 70. The latter brings the adjustment organ 58 of the adjustment pump 60 into its maximal open position, under the additional effect of the setting spring 74. If, subsequent to this, the proportional valve 56 opens (FIG. 3c), the consumer pressure p_{LS} is at first still less than the setting pressure of the spring 104 on the switching valve 100. Accordingly, the adjustment pump 60 works as a pressure-regulated pump, at first, so that a pressure up to the pressure set in the control group 107, by way of the pressure-limiting valve 108, of 250 bar, for example, can build up in front of the proportional valve 56. Finally, when the load pressure p_{LS} is greater than the setting pressure of the spring 104, the switching valve 100 reaches its closed position, so that the change-over valve 96 is opened by way of the load pressure p_{LS} in the line 98. From then on, the transport flow regulator 70 is guided by the load pressure. This means that the transport flow of the adjustment pump 60 is dependent on the throttle plate 57 of the proportional valve 56 switched between adjustment pump 60 and consumers 34, 35, . . . . The directional control valve 71 of the transport flow regulator 70 compares the pressure in front of the throttle plate 57 with that behind the throttle plate, and holds the pressure drop Δp=p−p_{LS} that occurs here, and therefore the volume flow, constant. The pressure regulator 72 that is additionally present is superimposed on the transport flow regulator 70, i.e. below the set reference pressure value at the pressure regulator 72 (e.g. 350 bar), the setting process in the adjustment pump 60 is guided by the load pressure.

Another pressure-limiting valve 110 ensures that the system pressure p in the feed line 64 does not exceed a pre-determined maximal value of 380 bar, for example.

The switching arrangement shown in FIG. 4 differs from the switching arrangement according to FIG. 3a to d in that the switching valve 100 has an electromagnetic pilot-control input 106′, which is controlled by way of a pressure switch 112 or pressure detector 114 that responds to the load pressure p_{LS}. The pressure switch 112 or the pressure detector 114 responds if the load pressure p_{LS} exceeds a certain minimum pressure, e.g. 100 bar. In this case, the spring 104′ on the switching valve 100 merely has a holding function. The spring force of this spring 104′ plays only a subordinate role, and can be very much lower than in the case of FIG. 3a to d.

In summary, the following should be stated: The invention relates to a hydraulic switching arrangement, particularly for the drive of concrete spreader masts. The switching arrangement comprises at least one hydraulic consumer 34, 35, . . . connected on the input side with the pressure output of a hydraulic adjustment pump 60, by way of a feed line 64, and at least one proportional valve 56 assigned to one of the consumers, disposed in the feed line 64, which valve blocks the feed line 64 in its rest position and forms a throttle plate 57 having a variable opening cross-section in its operating position. Furthermore, a rerouting group 82 is disposed in the feed line 64, connected with the tank 62 in the rest state, and with the at least one consumer 34, 35, . . . in the operating position. The adjustment pump 60 has an adjustment organ 58, which is controlled by way of a transport flow regulator 70 disposed in a pump branch 111, which regulator comprises a directional control valve 71, the one pilot-control input of which has the pump pressure p prevailing at the pressure output of the adjustment pump 60 applied to it, and whose opposite pilot-control input is spring-loaded with a defined bias force, and additionally has the load pressure p_{LS} prevailing behind the throttle plate 57 applied to it. In order to guarantee reliable operation also in the start-up phase, a control group 107 that responds to the load pressure p_{LS}, having a switching valve 100, is provided, which brings the adjustment organ 58 of the adjustment pump 60 into its position for maximal transport flow, below a pre-determined minimum value of the load pressure p_{LS}.

1. Hydraulic switching arrangement, particularly for the drive of concrete spreader masts (14), having at least one hydraulic consumer (34, 35, . . . ) connected on the input side with the pressure output of a hydraulic adjustment pump (60), by way of a feed line (64); having at least one proportional valve (56) assigned to one of the consumers, in each instance, disposed in the feed line (64), which valve blocks the feed line (64) in its rest position and forms a throttle plate (57) having a variable opening cross-section in its operating position; having a rerouting group (82) disposed in the feed line (64), connected with a tank (62) in the rest state, and with the at least one consumer (34, 35, . . . ) in the operating position; having an adjustment organ (58) disposed in the adjustment pump (60), which is controlled by way of a transport flow regulator (70) disposed in a pump branch, whereby the transport flow regulator (70) comprises a directional control valve (71), the one pilot-control input of which has the pump pressure (p) prevailing at the pressure output of the adjustment pump (60) applied to it, and whose opposite pilot-control input is spring-loaded with a defined bias force, and additionally has the load pressure (p_{LS}) prevailing behind the throttle plate (57) applied to it, wherein a control group (107) that responds to the load pressure (p_{LS}), which switches the load pressure of the directional control valve (71) through from the spring side, below a pre-determined minimum value of the load pressure, and, in this connection, brings the adjustment organ (58) of the adjustment pump (60) into its position for maximal transport flow (\dot{V}ₘₐₓ).

2. Switching arrangement according to claim 1, wherein the control group (107) has a switching valve (100) biased against the pressure of a setting spring (104), under the effect of the load pressure (p_{LS}), which switches the pump pressure (p) through to the spring side of the directional control valve (71) of the transport flow regulator (70), at a load pressure (p_{LS}) that is below the minimum value.

3. Switching arrangement according to claim 2, wherein the switching valve (100) has the load pressure (p_{LS}) directly applied to it at its pilot-control input that lies opposite the setting spring (104), and that the resulting pressure, set by way of the setting spring (104) corresponds to the minimum value of the load pressure.

4. Switching arrangement according to claim 2, wherein a pressure switch (112) or pressure detector (114) that responds to the minimum value of the load pressure, to which the load pressure (p_{LS}) is applied, is provided, and that the pilot-control input of the switching valve (100) that lies opposite the setting spring (104) is disposed in the circuit of the pressure switch (112) or pressure detector (114), and can be electrically and/or magnetically activated by the latter.

5. Switching arrangement according to claim 1, wherein the control group (107) is connected with the input of a change-over valve (96) by way of a throttle (106) on the output side, the second input of which valve has the load pressure (p_{LS}) applied to it, and whose output is connected with the spring side of the directional control valve (71) of the transport flow regulator (70).

6. Switching arrangement according to claim 1, wherein a pressure-limiting valve (108) disposed on the output side and connected with the tank (62) is connected with the control group (107).

7. Switching arrangement according to claim 1, wherein a pressure-limiting valve (110) connected with the tank (62) is disposed in the feed line (64).

8. Switching arrangement according to claim 1, wherein a pressure regulator (72) disposed behind the transport flow regulator (70) is disposed in the pump branch (111), in addition, to control the adjustment organ (58) of the adjustment pump (60).

9. Switching arrangement according to claim 1, wherein the adjustment organ (58) of the adjustment pump (60) is coupled with at least one setting cylinder (66, 68) activated by the transport flow regulator (70) and/or the pressure regulator (72).

10. Switching arrangement according to claim 9, wherein the at least one setting cylinder is spring-loaded, preferably in the opening direction of the adjustment organ (58).

11. Switching arrangement according to claim 1, wherein several consumers (34, 35, . . . ) are provided, to which a proportional valve (56) is assigned, in each instance, and that the load branches of the individual consumers (34, 35, . . . ) are connected with the control group (107) and its switching valve (100) by way of a change-over valve chain (94) that allows the highest load pressure signal (p_{LS}) to come through.

12. Switching arrangement according to claim 1, wherein the rerouting group (82) has a rerouting valve (54) that is optionally connected with the consumer (34, 35, . . . ) or the tank (62), from the feed line (64), and that a throttle (80) is disposed in the line leading to the tank (62).

13. Switching arrangement according to claim 12, wherein the rerouting group (82) has an input module with a spring-supported switching valve (84), which is connected with the feed line (64) on the input side and with the tank (62) on the output side, and is pilot-controlled on its spring side, by way of the output of the throttle (80), and has the pump pressure (p) applied to it on the pilot-control side that lies opposite the spring (88).

14. Switching arrangement according to claim 13, wherein the hydraulic pressure resulting from the spring force of the adjustable spring (88) of the input module is equal to or greater than the hydraulic pressure resulting from the spring force of the setting spring (74) of the transport flow regulator (70), so that the adjustment organ (58) of the adjustment pump (60) assumes its smallest open position (\dot{V}ₘᵢₙ) in the stand-by position of the rerouting group (82).

15. Switching arrangement according to claim 13, wherein the hydraulic pressure resulting from the spring force of the adjustable spring (88) of the input module is less than the hydraulic pressure resulting from the spring force of the setting spring (74) of the transport flow regulator (70), and is dimensioned in such a manner that the adjustment organ (58) of the adjustment pump (60) assumes a pre-determined intermediate position between its smallest possible and largest possible open position in the stand-by position of the rerouting group (82).

16. Hydraulic switching arrangement, particularly for the drive of concrete spreader masts (14), having at least one hydraulic consumer (34, 35, . . . ) connected on the input side with the pressure output of a hydraulic adjustment pump (60), by way of a feed line (64); having at least one proportional valve assigned to one of the consumers (34, 35, . . . ), in each instance, disposed in the feed line (64), which valve blocks the feed line (64) in its rest position and forms a throttle plate (57) having a variable opening cross-section in its operating position; having a rerouting group (82) disposed in the feed line (64), connected with a tank (62) in the rest state, and with the at least one consumer in the operating position; having an adjustment organ (58) disposed in the adjustment pump (60), which is controlled by way of a transport flow regulator (70) disposed in a pump branch, whereby the transport flow regulator (70) comprises a directional control valve (71), the one pilot-control input of which has the pump pressure (p) prevailing at the pressure output of the adjustment pump (60) applied to it, and whose opposite pilot-control input is spring-loaded with a defined bias force, and additionally has the load pressure (p_{LS}) prevailing behind the throttle plate (57) applied to it, wherein the rerouting group (82) has a switching valve (54) that is optionally connected with the consumer (34, 35, . . . ) or the tank (62), from the feed line (64), that a throttle (80) is disposed in the line leading to the tank (62), that the rerouting group (82) has an input module with a spring-supported switching valve (84), which is connected with the feed line (64) on the input side and with the tank (62) on the output side, and is pilot-controlled on its spring side, by way of the output of the throttle (80), and has the pump pressure (p) applied to it on the pilot-control side that lies opposite the spring (88), and that the hydraulic pressure resulting from the spring force of the adjustable spring (88) of the input module is equal to or greater than the hydraulic pressure resulting from the spring force of the setting spring (74) of the transport flow regulator (70), so that the adjustment organ (58) of the adjustment pump (60) assumes its smallest open position or its closed position, respectively, in the stand-by state of the rerouting group (82).

17. Hydraulic switching arrangement, particularly for the drive of concrete spreader masts (14), having at least one hydraulic consumer (34, 35, . . . ) connected on the input side with the pressure output of a hydraulic adjustment pump (60), by way of a feed line (64); having at least one proportional valve (56) assigned to one of the consumers (34, 35, . . . ), in each instance, disposed in the feed line (64), which valve blocks the feed line (64) in its rest position and forms a throttle plate (52) having a variable opening cross-section in its operating position; having a rerouting group (54, 82) disposed in the feed line (64), connected with a tank (62) in the rest state, and with the at least one consumer in the operating position; having an adjustment organ (58) disposed in the adjustment pump (60), which is controlled by way of a transport flow regulator (70) disposed in a pump branch, whereby the transport flow regulator (70) comprises a directional control valve (71), the one pilot-control input of which has the pump pressure (p) prevailing at the pressure output of the adjustment pump (60) applied to it, and whose opposite pilot-control input is spring-loaded with a defined bias force, and additionally has the load pressure (p_{LS}) prevailing behind the throttle plate (57) applied to it, wherein the rerouting group (82) has a switching valve (54) that is optionally connected with the consumer (34, 35, . . . ) or the tank (62), from the feed line (64), that a throttle (80) is disposed in the line leading to the tank (62), that the rerouting group (82) has an input module with a spring-supported switching valve (84), which is connected with the feed line (64) on the input side and with the tank (62) on the output side, and is pilot-controlled on its spring side, by way of the output of the throttle (80), and has the pump pressure (p) applied to it on the pilot-control side that lies opposite the spring (88), and that the hydraulic pressure resulting from the spring force of the adjustable spring (88) of the input module is less than the hydraulic pressure resulting from the spring force of the setting spring (74) of the transport flow regulator (70), and is dimensioned in such a manner that the adjustment organ (58) of the adjustment pump (60) assumes a pre-determined intermediate position between its smallest possible and largest possible open position (\dot{V}ₘᵢₙ, \dot{V}ₘₐₓ) in the stand-by position of the rerouting group (82).
